(19) United States
(12) Patent Application Publication
(10) Pub. No.: US 2007/0129880 A1
(43) Pub. Date: Jun. 7, 2007

(54) MAPS, ROUTES AND SCHEDULE GENERATION BASED ON HISTORICAL AND REAL-TIME DATA

(76) Inventor: Jeffery W. THACHER, Roswell, GA (US)

Correspondence Address: SMITH FROHWEIN TEMPEL GREENLEE BLAHA, LLC, Two Ravinia Drive, Suite 700, ATLANTA, GA, 30346, US

(21) Appl. No.: 11/308,364

(22) Filed: Mar. 19, 2006

Related U.S. Application Data
(63) Continuation-in-part of application No. 11/164,679, filed on Dec. 1, 2005.

(51) Int. Cl. G01C 21/32

(52) U.S. Cl. 701/202; 701/209; 340/995.19

(57) ABSTRACT

Mapping information can be generated and provided to a user to identify preferred routes and estimated travel times to traverse the preferred routes. The mapping information is initially generated based on mapping data obtained in a historical database. The mapping data can be retrieved based on the routes, the time and the date information. Thus, the preferred routes and travel times are identified and determined based on historical information, as well as distance and speed limit information. In addition, real-time information can be received from various sources, analyzed and then provided to a user to augment or update the mapping information.

### CROSS-REFERENCE TO RELATED APPLICATIONS

The present invention is a continuation-in-part of United States application for patent filed on Dec. 1, 2005 with a title of “GEO-FENCE LOCATION-SPECIFIC EQUIPMENT STATUS BASED TRIGGER DIRECTED CONTENT DELIVERY” and assigned Ser. No. 11/164,679.

This application is related to the following United States patent applications which were filed concurrently herewith and are incorporated herein by reference in their entirety:

Ser. No. 11/______ filed on ______, 2006 with a title of ______, and

Ser. No. 11/______ filed on ______, 2006 with a title of ______.

### BACKGROUND OF THE INVENTION

This invention relates to the fields of location devices and systems, and distributed geocentric location based systems and their application to cartography and, more particularly to utilizing historically collected data as well as real-time date from geocentric location based systems to generate accurate maps, along with routes and scheduling information.

The days of the thick, over-sized, brightly colored atlas filled with various coupons and advertisements seem to be approaching an end. Following right in suit is the cumbersome accordion fold-out map that once unfolded, can never be returned to its original condition. Sure, you can still find these archaic items in the stores, but for the most part, they seem to be covered in several layers of dust. They were quite useful in their day and time though. Just a couple decades ago, other than a gas station attendant, a waitress at a road side diner or a total random stranger standing on a street corner, the atlas and the accordion map were all we had to tell us how to get from here to there. And if you can actually remember them, the maps and the atlas' had little mile marker systems for providing an indication of the distance between points on the various roads. In addition, at the back of the atlas and/or map, there was usually a two dimensional grid that included starting points along one access and destinations along another access. The grid was then populated with miles and sometimes, estimated travel times.

The promulgation of the Internet, mapping and cartography databases, and sophisticated web-based software products has virtually changed the mapping industry. Power houses such as MAPQUEST, YAHOO, GOOGLE, MICROSOFT, as well as a host of others, have free and readily available web-based map generators that create color maps for requested locations, as well as mapping information between two points or locations. These maps generally include further details such as, mileage, estimated travel time based on distance and posted speed limits, as well as mile markers, driving instructions, sites and services available along the way. However, these services do not provide accurate travel time predictions based on anything other than miles and posted speed limits. Thus, as traffic patterns fluctuate, construction commences, accidents occur, etc., the accuracy of the travel times provided by these mapping services can be grossly inaccurate. Thus, other than the few benefits listed herein (i.e., listing of sites and services available along the route), the high-technology map generation systems are not much more sophisticated than a good old reliable atlas or accordion map. What is needed in the art is a map generating technique that can actually take into account various factors that have an effect on travel times and generate accurate maps and projected travel times.

Other services that have found there way into the domains of the Internet include weather reporting and traffic monitoring/alerts. Companies such as WEATHER.COM, CNN WEATHER, and YAHOO WEATHER offer up-to-date or near up-to-date weather information for various locations around the country and the world. In addition, cities such as Los Angeles, New York, Chicago and Atlanta, to name a few, have launched Internet based services to help people identify traffic problems and generate alerts to customers (e.g., email alerts) to provide notice of traffic problems. Also, the popular TRAFFIC.COM site provides traffic information and alerts for various cities throughout the country.

However, even in view of these Internet based services; there is still a great need in the art. What is needed in the art is a map generating system that can generate mapping information and printable road maps that are based on a more accurate depiction of what the traffic patterns and travel times will be at a specific point in time. In addition, there is a need in the art for customers of such a system to receive updated information regarding real-time events, such as weather, traffic, construction, etc. that can have an effect on the travel times. Also, there is a need in the art for such a solution to provide a customer with updated and alternate routes to help avoid problem areas and thus, maintain the quickest route for the driver based on current conditions.

### BRIEF SUMMARY OF THE INVENTION

The present invention addresses the above-identified needs in the art, as well as other needs in the art through providing a system and method for generating mapping information based on historical data as well as real-time data. In one embodiment of the invention, a user can access a map generating application to request mapping information. The user provides a map type indicator along with timing and/or date information. The map type indicator can be a variety of map types, such as point to point, intersection, area, region, city, road, etc. The application accesses a database or source of information that contains historical data relevant to the map type (i.e., for a route between two points, an intersection, a road, etc) and the time and/or date information provided. This information is then analyzed to generate mapping information that identifies a preferred route, road or intersection, along with estimated travel times. This information can be provided to the user in narrative form, graphic form or a combination of both. The application may also receive real-time information to augment the historical information. In one embodiment, the user may be presented with a user screen that allows the user to enable or disable the reception of real-time updates, determine the frequency of the updates, identify a means for providing notices or messages to the user and identify the types of information the user desires. When real-time data is received, the application can determine if it is relevant to the mapping information generated for the user and if so, formulate a message to transmit to the user.

These and other aspects, embodiments and features of the present invention are more fully described in the following description, figures and claims.

### BRIEF DESCRIPTION OF THE SEVERAL VIEWS OF THE DRAWING

FIG. 1 is a system diagram of the various components and devices of an exemplary system/environment that could be utilized to implement or support embodiments of the present invention.

FIG. 2 is a flow diagram illustrating the high-level operation of an embodiment of the present invention.

FIG. 3 is a simplified exemplary output of two-point route generated for an embodiment of the invention that receives a time and date entry.

FIG. 4 is a simplified exemplary output of a two-point route generated for an embodiment of the invention that receives a time entry only, assumes the current date as the relevant date, and provides an array of outputs depending on various assumed treatments of the date.

FIG. 5 is a simplified exemplary output of a two-point route generated for an embodiment of the invention that receives a date entry only, and assumes the current time as the beginning of a range of time, and provides an array of outputs depending on time over the range of time.

FIG. 6 is an exemplary screen of user interface for selecting and configuring real-time update information and messaging.

FIG. 7 is a flow diagram illustrating the steps involved in an exemplary embodiment of the real-time update aspect of the present invention for the delivery of alerts to a user.

### DETAILED DESCRIPTION OF THE INVENTION

The present invention, among other things, operates to generate mapping information for a user based on historical data that is relevant to the time, date and location pertaining to the requested mapping information. Furthermore, the user can receive updated information from real-time systems, such as traffic probes, to augment the mapping information.

More specifically, the present invention is a computer-based or web-based application that enables a user to generate mapping information that includes accurate travel time and alternate routing information based on historical information and/or real-time information. One aspect of the present invention is the generation of time/date relative mapping information. Advantageously, this aspect of the present invention allows a user to generate a map that will show expected routing and travel times based on expected conditions at a particular time and/or date. Another aspect of the present invention is the generation of real-time alerts that can be obtained or pushed to a user. Another aspect of the present invention is the identification of alternate traveling routes based on real-time or recent traffic, weather, construction, etc. information.

Although for illustrative purposes, the present invention is described within particular embodiments or applications, it should be appreciated that the present invention is not limited by these examples or applications. Rather, the present invention and aspects of the present invention can be incorporated into a variety of embodiments and applications without departing from the spirit and scope of the present invention. The primary application that is described herein is for the deployment of work forces within a new construction area. Turning now to the figures, in which like references identify like elements throughout the several view, embodiments, aspects and features of the present invention are described more fully.

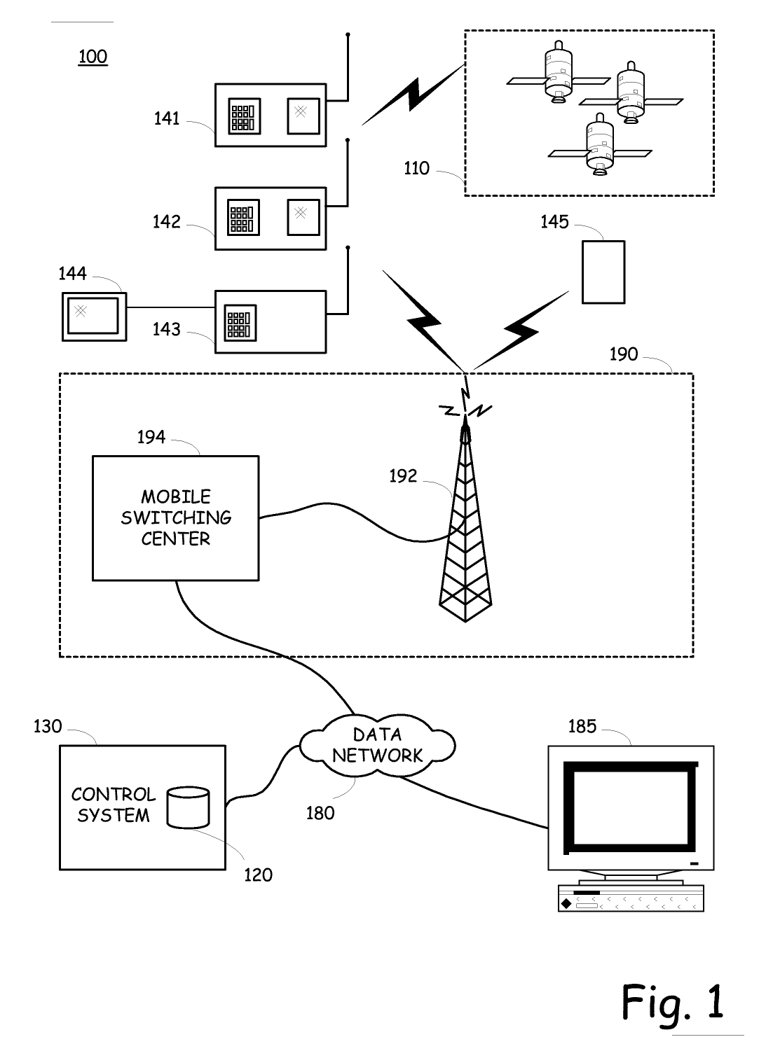

FIG. 1 is a system diagram of the various components and devices of an exemplary system/environment that could be utilized to implement or support embodiments of the present invention. The system 100 includes various components that are communicatively coupled to each other using various communication techniques. From the present inventions perspective, the key components include a workstation or computer 185 that interfaces to a web-based mapping application embodying the present invention and operating on a control system 130 or that includes the mapping application itself. Also of importance is a receiving device, such as mobile telephone 145 or other mobile units 141-143. In general, the computer 185 provides a user access to the mapping application, whether it is a resident program or a browser accessed web application. In addition, alerting or updated information can be sent to the computer 185 via a user's email account, or could be sent in other manners such as short messages to a mobile telephone, PDA, pager, etc 145 or mobile devices 141-143.

More generally, a geostationary orbiting satellite positioning system 110 operates to provide signals to mobile devices 141, 142 and 143. These satellite signals can be used by the mobile devices to identify the location of the mobile devices. The operation of such a typical geostationary orbiting satellite positioning system is well known to those skilled in the art. The most common satellite system that operates to provide such information is the Global Positioning System or GPS. The GPS is a constellation of twenty-four well-spaced satellites that orbit the Earth at 10,600 miles above sea level. The satellites are spaced at such intervals and altitude that for any given point on the Earth, at least four satellites will be communicatively seeable, or above the horizon. Each satellite in the GPS constellation includes a computer system, an atomic clock, and a transmitter. The satellites continuously transmit a data stream that identifies the current position of the satellite and the current time. Through the detection and decoding of these GPS signals, the mobile units are able to identify the longitudinal and latitudinal coordinates at which the mobile device is located. However, it should be appreciated that the present invention is not limited to operation with the GPS and other location technologies can also be utilized. Thus, when the term GPS is used within the context of this description, it is synonymous with other compatible location determining technologies unless otherwise stated.

The mobile devices 141, 142 and 143 are equipped to receive and/or determine location information, and also to transmit information to a dispatch and control or central system 130 through a communications medium. In the illustrated embodiment, the communications medium is a cellular telephone network utilizing technology such as GSM with GPRS, CDMA, TDMA, or similarly capable technologies. This technology enables the communication of data between the mobile devices and the control system. The cellular based data transmissions from the mobile devices 141, 142 and 143 are received by the mobile system 190 at antenna 192 and are provided to the mobile switching center 194. The mobile switching center then provides the received data transmissions to the control system 130 through a data network 180.

The control system 130 is also functional to transmit data to the mobile devices 141, 142 and 143 through the data network 180 and the cellular system 190. The control system 130 includes a database system 120 that houses, among other things, data utilized for various embodiments of the present invention. The mobile devices 141 and 142 are shown as including a display and a key pad. Such elements can be included in various embodiments of the present invention in addressing various aspects and functions of the invention and allow a user of the mobile device to review information received from the GPS transmitters and the control system, and to enter additional information to be provided back to the control system 130. However, it will be appreciated that other embodiments may not require such elements. The mobile device 143 is shown as interfacing to an external display device or an external device 144 that includes a display, such as a navigational system. In this embodiment, the control system can provide data to the external device 144 through the mobile device 143, or in other embodiments may directly provide data to the external device 144. Although not illustrated, it should be appreciated that the mobile devices may also interface to other data devices such as scanners, digital cameras, audio devices, analog to digital converters, an automobile data bus, measurement equipment, digital clocks, or other various devices.

The control system 130 includes the database system 120. The database system 120 can contain a variety of information depending on the various embodiments of the present invention. The database system 120 and the control system 130 may also be accessed via computer 185. Such a system allows the information in the database and information regarding the various mobile devices to be accessed from any computer system connected to the control system 130 through the data network 180. It should be appreciated that although FIG. 1 describes an exemplary environment that is suitable for the present invention, the present invention is equally applicable to other environments and is not limited to the illustrated environment. Rather, the illustrated environment has been provided as a non-limiting example of the operation of the present invention.

It will be appreciated that the system illustrated in FIG. 1 provides an adequate environment for the present invention in that it enables the mapping application to access historical mapping and traffic information as well as real-time information.

One aspect of the present invention is the generation of mapping information based on historical data. Advantageously, this aspect of the present invention enables a user to generate a map for a particular region or trip and have that map include travel time and route information based on the time and/or date that the user expects to be traveling. For example, when the user accesses the application, the user may be presented with a screen that requests the user to enter a route (such as entering a starting point and a destination or may include several points along the trip), a road, an intersection, or simply an area, region, city, etc. The user is also prompted to enter timing information. The timing information may include a time of day, a day of the week, a day of the month, range of times and dates, etc. The application then operates to access a historical database to generate mapping information based on the entered data. The mapping information can be presented in the form of a graphic map including roads, intersections, points of interests, etc, or may simply be a descriptive form.

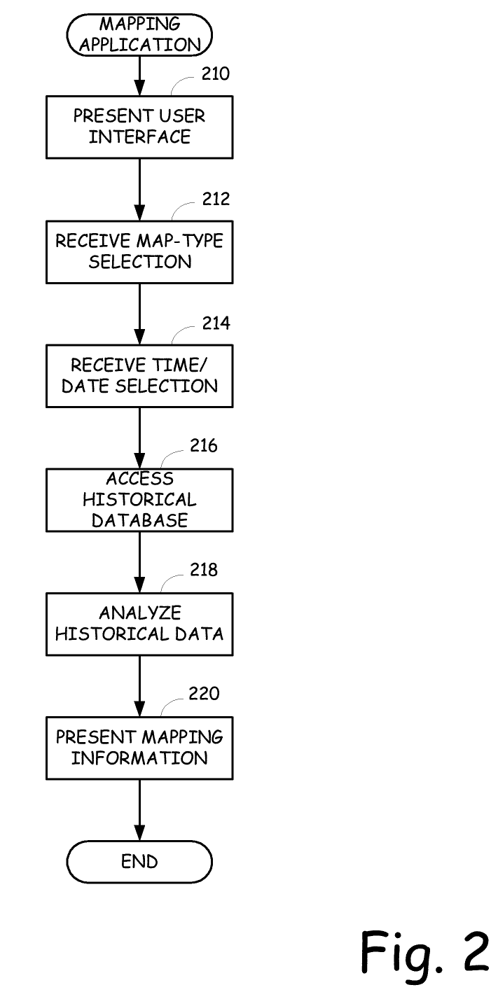

FIG. 2 is a flow diagram illustrating the high-level operation of an embodiment of the present invention. When a user accesses the application, the user is presented with a screen of the user interface 210. Again, the application is generally a web-based, but as mentioned above, the application could also be incorporated into a computer or work station that has a historical database or access a historical database over a local network or global network. The user interface screen includes allows the user to select type of mapping information to be generated. The type of mapping information available for user selection can vary from embodiment to embodiment but typical map types include: (a) routing maps from a start point to a destination; (b) multi-point routing maps; (c) intersection maps; (d) road specific maps; (e) area maps; and (f) city maps. It will be appreciated that although one or more of these map types, or any particular combination of these map types into such a mapping application may in and of itself be novel, the present invention is not limited to such map types and the present map types are presented as non-limiting examples. In addition, any particular embodiment may utilize one or a combination of the above listed map types, as well as other map types. Depending on the particular embodiment, the user then enters the map type selection 212.

The user interface screen also allows the user to enter the time/date information. The type of time/date information available for user selection can vary from embodiment to embodiment but typical time/date information includes: (a) time (including time of day, range of times, or a current time); (b) date (including day of the week, day of the month, day of the year, range of days); or (c) time and date including combination of the above-listed types. It will be appreciated that although one or more of these time/date entry types, or any particular combination of these time/date entry types into such a mapping application may in and of itself be novel, the present invention is not limited to such time/date entry types and the present time/date types are presented as non-limiting examples. Depending on the particular embodiment, the user then enters the time/date selection 214.

It should be appreciated that although the illustrated embodiment shows a map type selection and time date selection, an embodiment of the present invention may have one or both of these elements set to a default value and as such, the user does not have the option of selecting the actual input parameters. For instance, the default map type may be a route mapping and the user is forced to enter a start and a destination. The mapping information may then assume a date (i.e., the current date or current time plus an offset) and generate the mapping information accordingly.

Once the map type selection and the time/date selection, if any, are made, the historical database is queried to obtain relevant information 216. It should be understood that the historical database may includes a single database, collected and maintained by the entity providing the application. However, it may also be multiple databases distributed over the network, owned and operated by various vendors and may include portions that are private or publicly available. For instance, weather services and their databases may be queried (such as NOAH, Weather Channel, etc) and various Department of Transportation databases may be queried. In addition, various local databases, such as those available from a chamber of commerce or the like may be queried. Such databases may include relevant information such as town events that could impact traffic patterns. Thus, the historical data can be proprietary collected data such as the data collected in the system described in the above-referenced related patent application Ser. No. 11/______, commercially and publicly accessible data from other sources. The entries in the historical that are determined as relevant depend on the map type and the time/date selection, as well as other information. The relevant entries are then analyzed to generate the mapping information 218. The relevant entries can be analyzed in a variety of manners to derive the mapping information. For instance, the analysis may simply involve calculating the average the relevant historical values. Alternatively, the analysis may involve calculating a mean and a standard deviation for the relevant historical values. Other techniques may also be used such as calculating a range of values, defining a distribution (i.e., probabilities or historical percentages of a range of values), or canceling out extreme values and performing the analysis on the remaining historical values, etc. Thus, the calculations may use all of this historical data, or only a subset of the historical data. The historical data may be filtered based on extreme values, aging, changes that have occurred (i.e., a road or intersection may have been modified thus rendering historical data prior to the modification obsolete or less important) or the like. This historical data may also be filtered by user preference. For instance, the user interface may enable a user to define the amount of data to be examined (last X years, last X entries, etc). In addition, the historical data may be filtered based on a user's class of service. For instance, as a free service, the historical data maybe limited and to gain more accurate mapping information, a user may have to pay for a subscription. Also, if the user enters a range of times and/or dates, the historical data may be analyzed to generate a value based on the entries available over that range, or it may generate a range in response. Those skilled in the art will appreciate that many other techniques may be used to calculate the mapping information from the historical database and the present invention is not limited to any particular technique.

Finally, the mapping information is presented to the user in either a narrative format, graphic format or a combination of both 220.

The operation of an application incorporating an exemplary embodiment of the present invention can vary greatly depending on the map type and time/date selection data entered. As such, several examples are provided below.

Routing Maps. Routing maps general provide mapping information related to a starting point and a stopping point. The displayed information can be driving instructions and/or a graphical map with a route plotted on the map. Routing maps can also be generated as multi-point routes. In essence, this is the equivalent of having multiple starting points and multiple destinations. However, a multi-point routing map can also be generated as best route maps. For instance, if a delivery truck is going to visit 12 destinations, each of these destinations are entered and then a best route is generated. The best route identifies the order to traverse the destinations and the routes to take. As will be described below, once this feature is coupled to the time/date data, a best route can be calculated taking into consideration traffic fluctuations throughout the day.

Intersection Maps. The mapping information may be generated for a particular intersection. Such information will allow a user to determine whether to take an alternate route or avoid a trip altogether.

Road Specific Maps. The mapping information may be generated for a specific road or a portion of a specific road. For instance, rather than entering a start and destination, a user may simply want mapping information for a road that will be traveled on a particular trip. Because some roads can be considerably long, the road specific maps may be limited to a particular state, county, or range.

Area Maps. The mapping information may be generated for a particular area, such as a 50 mile radius from a current location or a point of interest.

City Maps. The mapping information may be generated for a particular city.

For the area and city maps, travel times can be depicted by providing a starting point/destination matrix.

The following examples of the operation of this aspect of the present invention assume that a user is requesting a two-point routing map and the examples illustrate the operation of exemplary embodiments of the invention for various time/date entries. In general, when a user requests a two-point routing map, the generated mapping information identifies a best route for the user to travel, the amount of distance to be traveled and the estimated travel time based on the historical data that is relevant to the entered time/date selection.

Time Only. If a user enters only a time for the time/date selection, the application may assume that the date is irrelevant or, it may assume that the relevant date is the current date. If the date is assumed to be irrelevant, the historical data may include all data available for the particular time. Thus, regardless of the day of the week, month or year, the historical data for the entered time can be considered the relevant data. Alternatively, the current date may be assumed as the relevant date. Under this assumption, a further assumption can be made, for instance the current date is representative of a day of the week, day of the month or day of the year. Alternatively, mapping information can be generated for each of these three assumptions.

In addition, the time only entry can be made in a variety of manners. The user may enter a particular time, a range of times (e.g., certain hours or predefined ranges such as morning rush, lunch rush, evening rush) or the current time with or without an offset can be entered. For an embodiment accepting a range of times, the invention may operate to give an average of the relevant historical data during that range or, it may generate a range of mapping information that shows travel times and best routes over the range of time. For instance, a first route may be preferred for a first time period with the following travel time ranges based on the time of day and at a particular time; a second route may be preferred.

Date Only. If a user enters only a date for the time/date selection, the application may assume that the time is irrelevant or, it may assume that the relevant time is the current time, the current time plus an offset or a range of time related to the current time. If the time is assumed to be irrelevant, the historical data may include all data available for the particular date. Thus, regardless of time of day, the historical data for the entered date can be considered the relevant data. Alternatively, the current time or the current time plus an offset may be assumed to be the relevant time. As another alternative, mapping information may be generated for the entire date or a subset of the date (i.e. 8:00 AM to 7:00 PM). In analyzing this data, the relevant date for the date can be averaged or mapping information can be generated for various slots in the time range for the entered date.

In addition, the date only entry can be made in a variety of manners. The user may enter a particular date, a range of dates, a day of the week, a day of the month, a particular holiday, etc. For an embodiment accepting a range of dates, the invention may operate to give an average of the relevant historical data during that range or, it may generate a range of mapping information that shows travel times and best routes over the range of dates. For instance, a first route may be preferred for a first date with the following travel time ranges based on an assumed time of day and, a second route may be preferred for a second date.

Time and Date. If the user enters a time and date, the relevant historical data can be obtained for the entered data. The time and date information can be entered in accordance with any of the above-identified combinations and the identification of the relevant data and the analysis will vary accordingly.

Thus, various embodiments of the present invention can generate mapping information for a two-point route for various time/date selections or entries. The resulting information is either a slice in time view of the best route with travel times based on the entered data and/or assumptions made, or, a range of best routes and travel times can be provided.

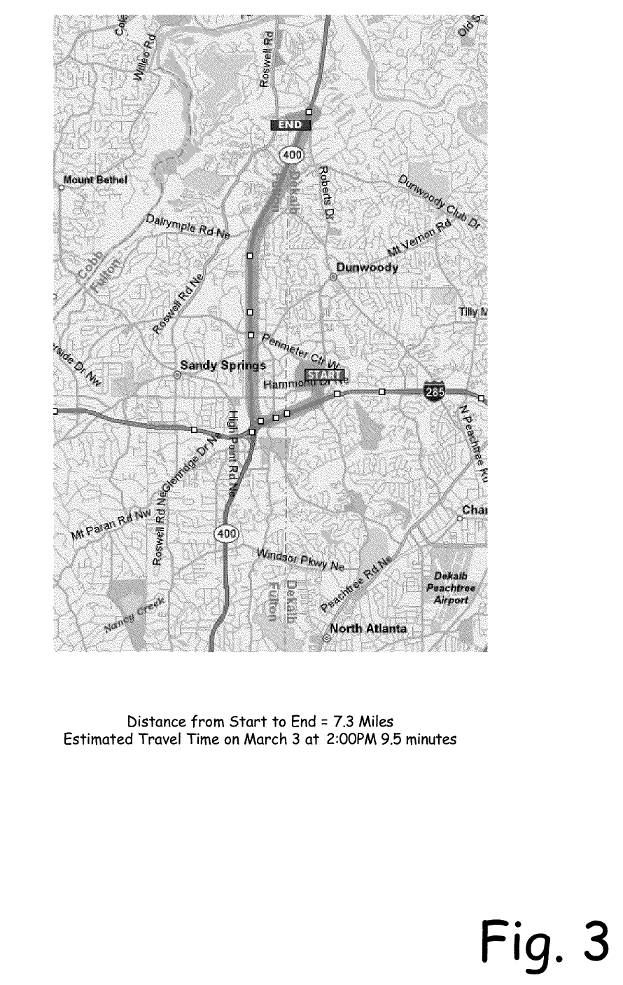

FIG. 3 is a simplified exemplary output of two-point route generated for an embodiment of the invention that receives a time and date entry. The mapping information show a preferred route and then lists the distance between the start and stop points (7.3 miles), as well as the estimated travel time (9 minutes and 30 seconds) for the identified date (March 3) and time (2:00 PM). The historical data in this example could be based on viewing the date as a day of the week, month or year entry.

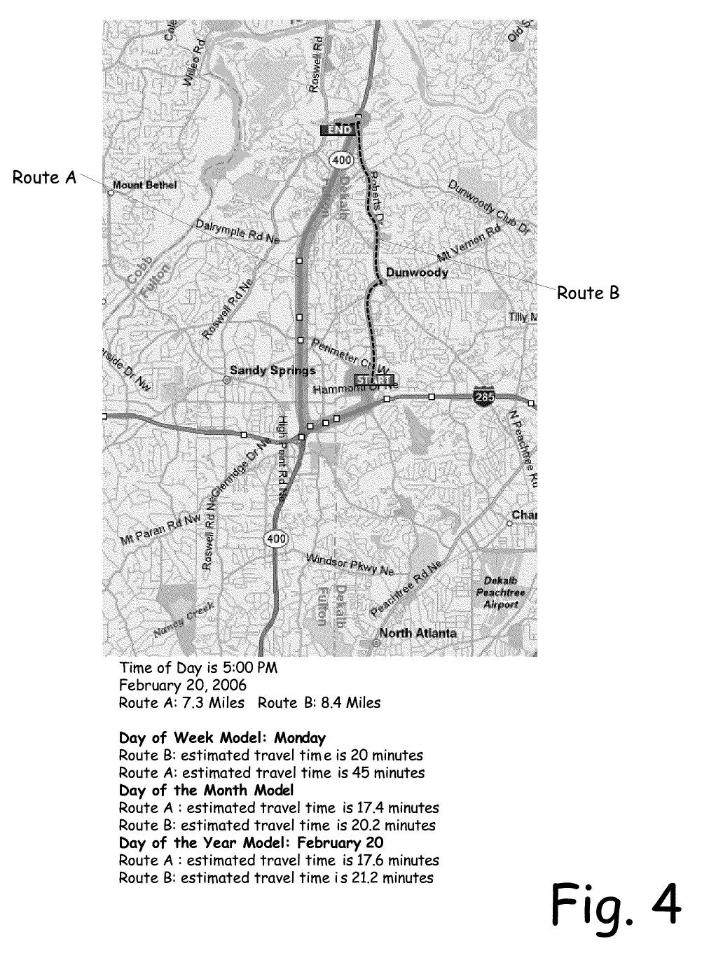

FIG. 4 is a simplified exemplary output of a two-point route generated for an embodiment of the invention that receives a time entry only, assumes the current date as the relevant date, and provides an array of outputs depending on various assumed treatments of the date. In the illustrated example, the time entered is 5:00 PM. The date of the entered request is Feb. 20, 2006 which is a Monday. The application generates mapping information for traveling from the starting location to the stopping location for 5:00 PM under the following scenarios:

Current date represents a day of the week—historical data is limited to Mondays;

Current date represents a day of the month—historical data is limited to the 20 of preceding months;

Current date represents day of the year—historical data is limited to February 20 for preceding years.

As can be seen in FIG. 4, the results can vary greatly depending on the assumptions made as well as the entered data. In the illustrated output, two routes are generated. Route A is a distance of 7.3 miles and Route B is a distance of 8.4 miles. Under the day of the week model, the historical data for Mondays is examined. The analysis of this data generates a time of 20 minutes for Route B and 45 minutes for Route A. Under the Day of the Month Model, the time for Route A is 17.4 minutes and for Route B is 20.2 minutes. Finally, under the Day of the Year model, the travel time for Route A is 17.6 minutes and for Route B is 21.2 minutes. Advantageously, the information allows the user to make a choice. For instance, for Feb. 20, 2006, the user may be most interested in Monday traffic patterns and as such, he is most likely going to take Route B. However, if the date entered was for Oct. 31, 2006 (a Tuesday), the user's decision may be quite different. In this scenario, October 31 is Halloween and as such, the user may not care about Tuesday traffic patterns but rather is greatly concerned about the Day of the Year model. Advantageously, such an embodiment of the present invention provides flexibility to the user in selecting a route.

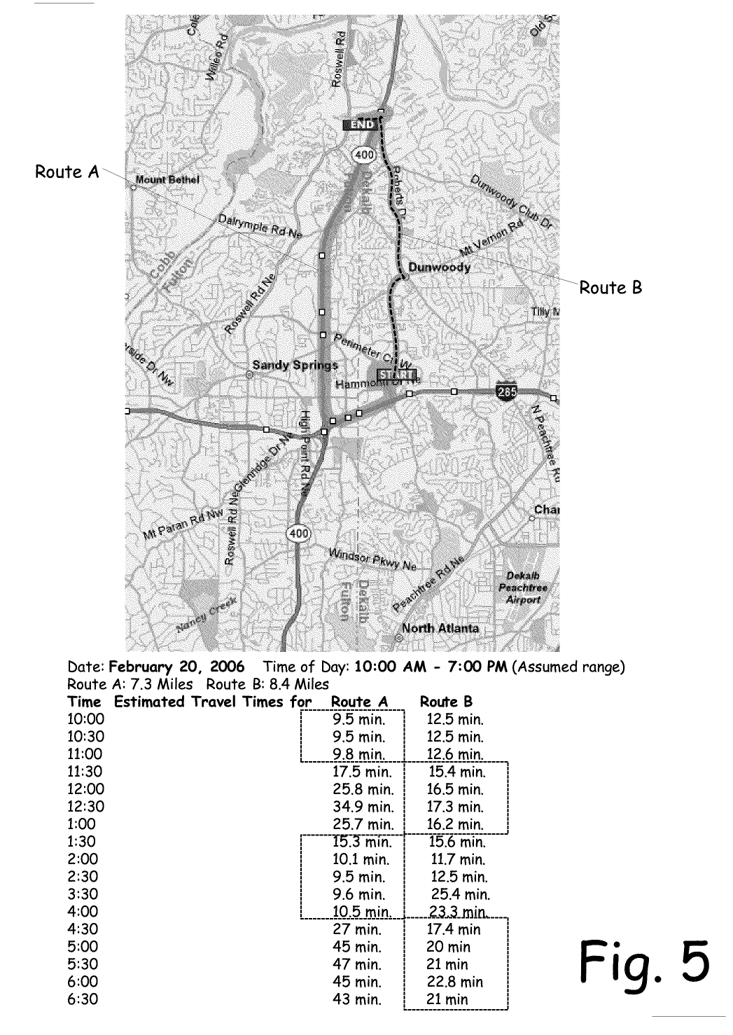

FIG. 5 is a simplified exemplary output of a two-point route generated for an embodiment of the invention that receives a date entry only, and assumes the current time as the beginning of a range of time, and provides an array of outputs depending on time over the range of time. Thus, the output illustrated in FIG. 5 includes a table of times from 10:00 AM to 6:30 PM with the travel times for two routes. The preferred route is shown as outlined by a dotted line.

In addition to the historical data, embodiments of the present invention may also rely on current, near real-time and even real-time data for generating the mapping information, as well as sending augmented status messages to a user.

The current, near real-time and real-time information can be gathered from a variety of sources and means. For instance, as previously mentioned, an embodiment of the present invention can query other data bases, commercially or publicly available, as well as private databases if access is granted, to obtain not only historical data but also current to real-time data. For instance, the WEATHERCHANNEL.COM site could be queried to identify weather conditions at a particular time/date for which traffic is being analyzed. Based on this information, as well as other historical information, the mapping information may be generated. Other types of information may include construction schedules and project descriptions (i.e., closed lanes or ramps), as well as traffic reports available from Department of Transportation databases. In addition, public service databases may be accessed to obtain information about traffic accidents. A huge variety of other information can be obtained from various places and entities. A few non-limiting examples include: local school schedules, local holidays, local events (i.e., concerts, parades, races, etc), shift changes for large companies, political candidate visits, etc.

In addition, the above-cited related patent application describes a system for the collection of real-time data from data probes deployed on user vehicles or other vehicles or devices. This information provides live, real-time updated data. The problem associated with the real-time data is that in some embodiments of the invention, the user has already generated his map and is on the road. How is the real-time data going to help out the user?

Another aspect of the present invention is the use of pushed information to update a user with this real-time information. The push can be performed in a variety of manners, including but not limited to emails, short messaging services SMS, text messaging, paging, voice calls, etc. In one embodiment, when the user is entering the map type and time/date selection information, the user may also enter a method for receiving pushed information, such as entering his email address. An exemplary embodiment may also allow the user to enter other parameters about the type of information requested and the frequency of receiving the information. For instance, the user may want to receive updated information every 2 minutes. In addition, the user may have the opportunity to enter types of requested information and triggering thresholds to help limit the amount of information he is receiving.

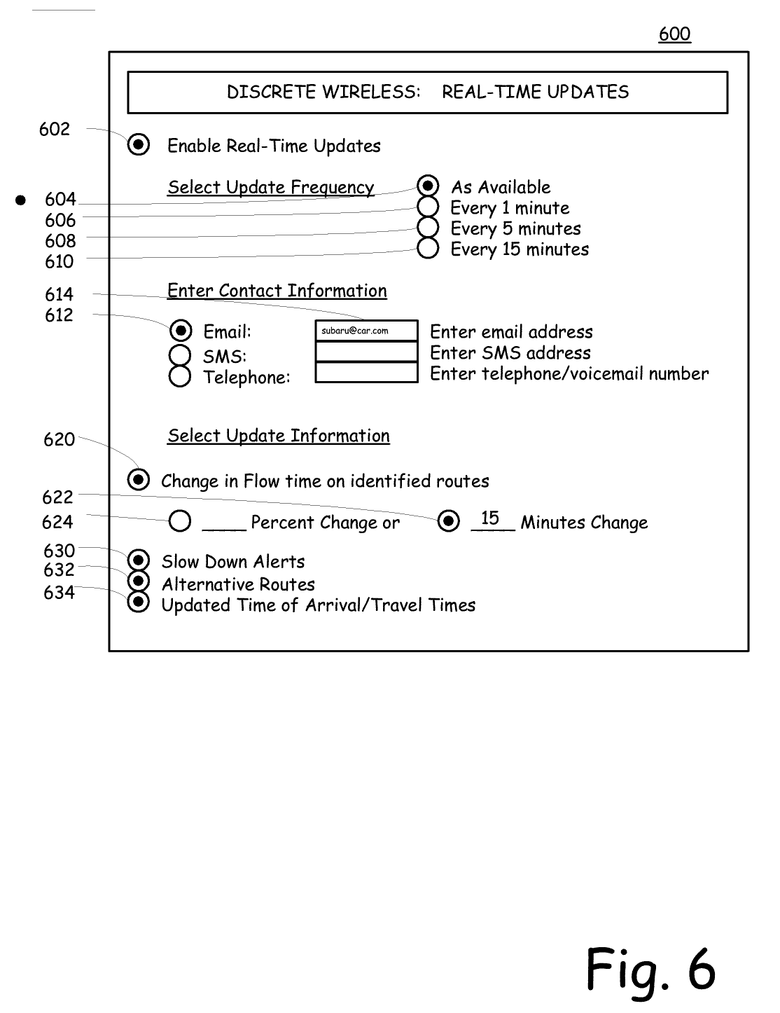

FIG. 6 is an exemplary screen of user interface for selecting and configuring real-time update information and messaging. The various features and parameters listed are only provided as a non-limiting example and those skilled in the art will appreciate that other variables and parameters could be easily incorporated into the present invention. The illustrated screen 600 provides the option for a user to enable or disable real-time updates by selecting or deselecting radial button 602. If enabled, the user may also enter an update frequency by selecting one of the radial buttons 604-610. Alternatively, a default may be selected automatically when the user enables real-time updates. The user can then select a method for receiving the updated information. As illustrated, the options of email, SMS and telephone calls are listed. However, those skilled in the art will appreciate that other methods may also be incorporated, such as integrating with available GPS and ONSTAR technologies and delivery the updates through those systems. In the illustrated embodiment, radial 612 has been selected to enable email delivery and an email address has been provided in block 614.

The screen also includes a section to allow a user to identify the types of information he wishes to receive. By selecting radial button 620, the user can enable change in flow updates for the routes identified in the mapping information. The user also can select the updates to occur is the change is a certain amount of minutes different 622 or a certain percentage 624. Thus, in the present configuration if the change in traffic flow for a particular route (such as route A in FIG. 5) exceeds a particular number of minutes (15 minutes as illustrated), the user would receive an email message informing him of such.

In the illustrated screen, the slow down alerts radial is selected 630. This option allows the user to be notified of slow down conditions and thereby puts the user on alert. The slow down alert may identify a location of the block as well as the location of the release of the congestion or slow area. Such information helps the user from a safety perspective as well as taking alternate measures to avoid the slow down.

In the illustrated screen, the alternative routes radial is selected 632. This option enables alternate routing information to be sent to the user when the current route is experiencing problems. The triggering event for this could be tied into the user's selection of the change in flow time (622 or 624) or may be an independent user or system variable. Regardless, the user receives updated mapping information that identifies a new route as well as estimated travel times.

In the illustrated screen, the updated time of arrival/travel times radial is selected. When this feature is selected, the user will receive notifications regarding changes in the estimated travel time based on the real-time traffic conditions.

An application embodying the present invention can receive the real-time information and determine if the information is applicable to the user's recently generated and potentially active maps. If the user has enabled reporting, the application may simply assume that the map use is active. If the real-time data applies, the selected or enabled options are reviewed to determine if and how the user should be notified. Finally, if applicable the user is notified with the real-time information.

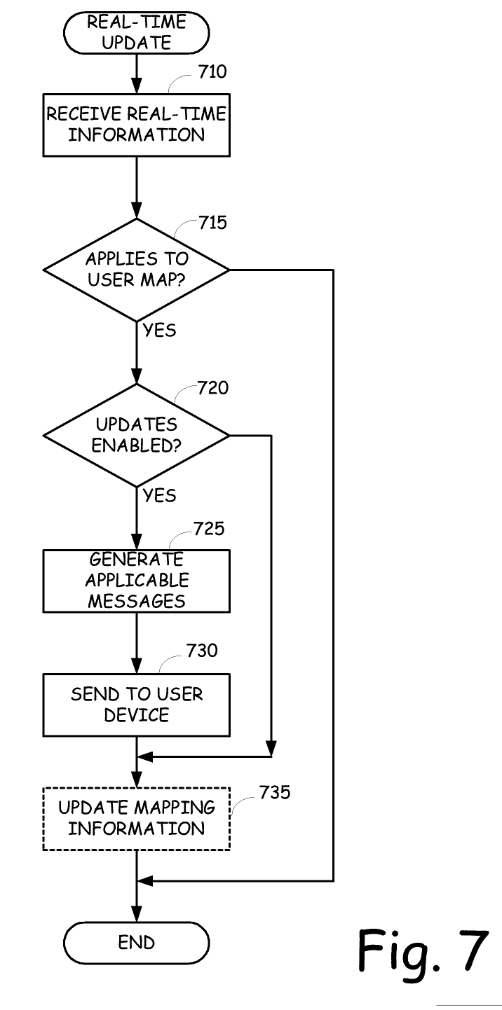

FIG. 7 is a flow diagram illustrating the steps involved in an exemplary embodiment of the real-time update aspect of the present invention for the delivery of alerts to a user. During operation, the application or system embodying the present invention may receive real-time information in one of the variety of afore-mentioned manners or in other ways 710. Once this information is received, the application needs to determine if the real-time information is applicable to mapping information generated by or for a user 715. For instance, if a traffic incident is reported on a particular road, the system can identify all of the users that requested mapping information that included traveling on and/or near that road. In addition, the application may examine the time/date information for that mapping information to further determine if the real-time information is applicable. For instance, if a user requested mapping information for the time period of 2:00 PM to 5:00 PM and the real-time information is applicable to 7:00 AM, the application may determine that the residual effects of the traffic incident will not apply at that time and thus, will not provide any updated information. However, as time passes, if the area still shows a slow down or congested state, as the user's mapping information window approaches, the application may decide to update the user. If the real-time information is not applicable to a user's mapping information, processing is halted or discontinued for this real-time information.

If the application determines that the real-time information is applicable to a user's mapping information, the application then examines if that user has enabled real-time updates 720. If real-time updates are enabled, the application then generates any applicable messages (emails, SMS messages, text messages, voice calls, ONSTAR messages, etc) 725 and the proceeds to send the messages to the user or the user's device 730. Optionally, some embodiments of the invention, regardless of whether the user has enabled real-time updates, the mapping information pertinent to the real-time information can be updated at the application level 735. This operates to keep the mapping information current in the event that the user accesses the information again prior to embarking on the trip.

It will be appreciated that the computer 185 in FIG. 1 can be a mobile device and operate within a vehicle. As such, the provision of real-time updates in accordance with step 730 or step 735 in FIG. 7 may be the same process. As such, not only can the user receive updated mapping information or alerts, but the actual maps and driving directions can be automatically updated on the user screen. Thus, the present invention can be incorporated into in-vehicle navigational systems

Multi-point mapping example. As an example to further illustrate the operation of an embodiment of the present invention, a multi-point mapping example is provided. In this example, the user is assumed to be a delivery man that must make multiple stops on a particular day. Prior to embarking on his rounds, the user enters the list of destinations into a user screen presented by an embodiment of the present invention and, the time and date that the user will start the route. Based on this information, the embodiment of the invention can generate a best route for the user to take for traversing the various points and, provide estimated travel times. In some embodiments of the invention, the user may even be able to enter delays that will be expected at each of the visited sites. This information can also be used in calculating the best route for the user.

After the user embarks on his rounds, circumstances may arise that could have an effect on the travel times as well as the best route. If an event occurs that has a significant effect on the route, the exemplary embodiment of the present invention can provide updated information to the user. The updated information may simply include revised travel times. However, the updated information may also include the identification of alternate routes for the user to take and may even alter the order in which the various destinations are visited.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or aspects or possible combinations of the features or aspects. Variations of embodiments of the present invention that are described and embodiments of the present invention comprising different combinations of features noted in the described embodiments will occur to persons of skilled in the art. The present invention may be implemented by any one of, or any combination of, software, hardware, and/or firmware. In the description and claims, each of the verbs, “comprise” “include” and “have”, and conjugates thereof, are used to indicate that the object or objects of the verb are not necessarily a complete listing of members, components, elements or parts of the subject or subjects of the verb.

What is claimed is:

1. A system for generating mapping information, the system comprising:
a control system;
a database of historically based relevant information;
a user interface for receiving a map type;
an interface for receiving timing information;
based on the map type, the timing information and the historically based relevant information, generating mapping information that includes a preferred route and estimated travel time that is calculated based at least in part on the historically based relevant information and the timing information.

2. The system of claim 1, wherein the interface for receiving timing information is a user interface and is able to receive a time.

3. The system of claim 2, wherein the time is a range of times.

4. The system of claim 1, wherein the interface for receiving timing information is a user interface and is able to receive a date.

5. The system of claim 1, wherein the interface for receiving timing information is a user interface and is able to receive a time and a date.

6. The system of claim 1, wherein the interface for receiving timing information is a user interface and is able to receive a day of the week.

7. The system of claim 1, wherein the historical database includes recorded travel information for previous dates and times.

8. The system of claim 1, wherein the historical database includes publicly available weather and traffic databases.

9. The system of claim 1, further comprising:
a real-time data interface operable to receive real-time traffic related information from one or more sources;
a user interface for enabling the reporting of real-time information relevant to a user's mapping information; and
a user device interface for transmitting real-time messages based on the reception of relevant real-time information to a user device.

10. A method for providing mapping information to a user, the method comprising the steps of:
receiving a map type indicator;
receiving timing information;
accessing a data source of mapping data indexed at least by the timing information;
analyzing the mapping data; and
generating mapping information based on the map type indicator, the timing information and the database of mapping data.

11. The method of claim 10, wherein the step of accessing a data source comprises the step of accessing a historical database containing mapping data based on the timing information.

12. The method of claim 10, wherein the map type indicator includes an identification of a starting point and a stopping point and the step of accessing a data source comprises the step of accessing a historical database containing mapping data based on the timing information.

13. The method of claim 12, wherein the step of generating mapping information further comprises generating a preferred route and an estimated travel time based on the historical database.

14. The method of claim 12, wherein the data source includes a source of updated mapping data and further comprising the steps of:
receiving updated mapping data from the data source;
determining if the updated mapping data is relevant to the generated mapping information; and
updating the generated mapping information.

15. The method of claim 12, wherein the data source includes a source of updated mapping data and further comprising the steps of:
receiving updated mapping data from the data source;
determining if the updated mapping data is relevant to the generated mapping information;
forming a message containing the relevant updated mapping data; and
sending the message to a user device.

16. The method of claim 12, wherein the timing data includes a range of times and the step of generating the mapping information further comprises generate a first preferred route for a first subset of the range of times and a second preferred route for a second subset of the range of times.

17. The method of claim 12, wherein the data source includes a source of real-time updated mapping data and further comprising the steps of:
presenting a user interface for enabling the reception of real-time updates to be delivered to a user device;
receiving real-time updated mapping data from the data source;
determining if the updated mapping data is relevant to the generated mapping information for a particular user; and
transmitting the relevant real-time updated mapping information to the user device of the particular user.

18. The method of claim 13, wherein the step of transmitting real-time updated mapping information comprises transmitting a new estimated travel time.

19. A method for generating mapping information for a particular user and providing real-time updates to that information, the method comprising the steps of:
receiving a map type indicator identifying a starting point and a stopping point from a user;
receiving timing and date information from the user
accessing a data source of mapping data indexed by the timing and date information;
analyzing the mapping data;
generating mapping information based on the map type indicator, the timing information and the database of mapping data;
providing the mapping information to the user;
receiving an real-time updates enabled indicator from the user;
receiving real-time updated mapping information from the data source;
determining the real-time updated mapping information is relevant to the mapping information generated for the user; and
providing the relevant real-time updated mapping information to the user.

20. The method of claim 19, wherein the step of analyzing the mapping data comprises determining an estimated travel time over a preferred route between the starting point and the stopping point by examining historically related data for the preferred route based on the timing and date information.
